(19) United States
(12) Patent Application Publication
(10) Pub. No.: US 2013/0100938 A1
(43) Pub. Date: Apr. 25, 2013

(54) APPARATUS FOR PERFORMING UPLINK SYNCHRONIZATION IN MULTIPLE COMPONENT CARRIER SYSTEM AND METHOD THEREFOR

(71) Applicant: PANTECH CO., LTD., Seoul (KR)

(72) Inventors: Ki Bum KWON, Seoul (KR); Jae Hyun AHN, Seoul (KR); Myung Cheul JUNG, Seoul (KR)

(73) Assignee: PANTECH CO., LTD., Seoul (KR)

(21) Appl. No.: 13/658,308

(22) Filed: Oct. 23, 2012

(30) Foreign Application Priority Data
Oct. 24, 2011 (KR) 10-2011-0108887
Sep. 17, 2012 (KR) 10-2012-0102771

(51) Int. Cl. H04W 72/04

(52) U.S. Cl. 370/336

(57) ABSTRACT

There are provided an apparatus for performing uplink synchronization in a multiple component carrier system and a method thereof. The method includes determining whether a timing advance value for adjusting uplink timing of a secondary serving cell is valid, entering a transmission holding mode in which the secondary serving cell holds uplink transmission, and determining a releasing condition of releasing the transmission holding mode is satisfied. The timing advance value is secured and the validity of the timing advance value is determined so that it is possible to prevent uplink interference from being generated due to a difference in timing advance values and to prevent capability from deteriorating due to the uplink interference.

### CROSS-REFERENCE TO RELATED APPLICATION

This application claims the priority benefit of Korean Patent Application No. 10-2011-0108887, filed on Oct. 24, 2011 and Korean Patent Application No. 10-2012-0102771, filed on Sep. 17, 2012 in the Korean Intellectual Property Office, the disclosure of which is incorporated herein by reference.

### BACKGROUND OF THE INVENTION

1. Field of the Invention

The present invention relates to wireless communications, and more particularly, to an apparatus for performing uplink synchronization in a multiple component carrier system and a method thereof.

2. Description of the Related Art

In a common wireless communication system, although bandwidth of an uplink is different from bandwidth of a downlink, only one carrier is mainly considered. A third generation partnership project (3GPP) long term evolution (LTE) is based on a single carrier so that only one carrier forms the uplink and the downlink and that the bandwidth of the uplink is commonly symmetrical with the bandwidth of the downlink. In the single carrier system, random access is performed using one carrier. Recently, as a multiple component carrier system is introduced, random access may be realized through a number of component carriers.

The multiple component carrier system means a wireless communication system capable of supporting carrier aggregation. In the carrier aggregation as a technology of efficiently using broken small bands, in a frequency region, a plurality of physically non-continuous bands are bound so that effect of using a large band is logically obtained.

In order for user equipment (UE) to access a network, a random access procedure is performed. The random access procedure may be divided into a contention based random access procedure and a non-contention based random access procedure. The largest difference between the contention based random access procedure and the non-contention based random access procedure lies in whether a random access preamble is dedicated to one UE. In the non-contention based random access procedure, since the UE uses a random access preamble dedicated only thereto, contention (or collision) with another UE is not generated. Here, contention refers that at least two UEs perform the random access procedure using the same random access preamble through the same resource. In the contention based random access procedure, since the UE uses an arbitrarily selected random access preamble, there is probability of contention.

The UE performs the random access procedure for initial access, handover, scheduling request, timing advance, etc. Clear definition on a method of determining validity of a timing advance value and a method of performing uplink synchronization in accordance with an activation or deactivation operation of a secondary serving cell in the multiple component carrier system must be provided.

### SUMMARY OF THE INVENTION

An object of the present invention is to provide an apparatus for performing uplink synchronization in a multiple component carrier system and a method thereof.

Another object of the present invention is to provide an apparatus for determining validity of a timing alignment value and a method thereof.

Still another object of the present invention is to provide an apparatus for performing uplink synchronization in accordance with activation or deactivation of a secondary serving cell and a method thereof.

Still another object of the present invention is to provide an apparatus for releasing uplink transmission holding caused by invalidity of a timing alignment value and a method thereof.

An aspect of the present invention provides a method of performing uplink synchronization by user equipment (UE). The method includes determining whether a timing advance value for adjusting uplink timing of a secondary serving cell is valid, of entering a transmission holding mode of holding uplink transmission in the secondary serving cell when the timing advance value is not valid, and determining whether a releasing condition of releasing the transmission holding mode is satisfied.

Determining whether the timing advance value is valid includes measuring a first downlink timing value in a first duration and a second downlink timing value in a second duration and determining whether the absolute value of a difference between the first downlink timing value and the second downlink timing value is no less than a threshold value. The UE determines that the timing advance value is valid when the absolute value is no less than the threshold value and determines that the timing advance value is not valid when the absolute value is less than the threshold value.

The first duration may be defined as from the time at which deactivation of all of the serving cells in a timing advance group (TAG) including the secondary serving cell is determined to the time at which all of the serving cells are deactivated. The second duration may be defined as from the time at which activation of at least one serving cell in the TAG is determined to the time at which the at least one serving cell is activated.

The first downlink timing value and the second downlink timing value may be measured based on the downlink timing reference of the secondary serving cell

In the releasing condition, uplink grant indicating resource for the uplink transmission is received.

In the releasing condition, information of requesting the UE to transmit a sounding reference signal (SRS) or channel quality information (CQI) is received.

When the releasing condition is not satisfied, the UE may stand by until a time alignment timer (TAT) indicating the valid period of the timing alignment value expires.

When the TAT expires, receiving an indicator indicating initiation of the random access procedure from the base station may be further included.

When the releasing condition is not satisfied, the UE may perform a timing advance value updating procedure.

The time alignment updating procedure may include transmitting a release request message for requesting the transmission holding mode to be released to the base station.

The release request message may be a message for requesting initiation of a random access procedure used for requesting an updated timing advance value.

The release request message may be transmitted to a serving cell in a TAG including a primary serving cell.

Another aspect of the present invention provides a UE for performing uplink synchronization. The UE includes a mode controller for determining whether a timing advance value for adjusting the uplink timing of the secondary serving cell is valid, for configuring the UE in a transmission holding mode of holding the uplink transmission in the secondary serving cell when the timing advance value is not valid, and for determining whether a releasing condition of releasing the transmission holding mode is satisfied, and a UE transmitting unit for transmitting an uplink signal from the secondary serving cell to the base station based on the uplink timing in accordance with the timing advance value when the mode controller determines that the releasing condition is satisfied.

In the mode controller determining whether the timing advance value is valid, the first downlink timing value is measured in the first duration, the second downlink timing value is measured in the second duration, it is determined that the timing advance value is valid when the absolute value of the difference between the first downlink timing value and the second downlink timing value is no less than the threshold value, and it is determined that the timing advance value is not valid when the absolute value is less than the threshold value.

The first duration may be defined as from the time at which deactivation of all of the serving cells in a timing advance group (TAG) including the secondary serving cell is determined to the time at which all of the serving cells are deactivated. The second duration may be defined as from the time at which activation of at least one serving cell in the TAG is determined to the time at which the at least one serving cell is activated.

In the mode controller determining that the releasing condition is satisfied, the uplink grant indicating resource for the uplink transmission may be received from the base station.

In the mode controller determining that the releasing condition is satisfied, information of requesting the UE to transmit the SRS or the CQI is received from the base station.

When the mode controller determines that the releasing condition is not satisfied, a random access processing unit that stands by until the TAT indicating the valid period of the timing advance value expires may be further included.

When the TAT expires, the random access processing unit generates an indicator indicating the initiation of the random access procedure and the UE transmitting unit may transmit the indicator to the base station.

When the mode controller determines that the releasing condition is not satisfied, the random access processing unit may perform the timing advance value updating procedure.

### BRIEF DESCRIPTION OF THE DRAWINGS

FIG. 1 illustrates a wireless communication system according to the present invention;

FIG. 2 illustrates a protocol structure for supporting multiple component carriers according to the present invention;

FIG. 3 illustrates an example of a frame structure for describing operations of the multiple component carriers according to the present invention;

FIG. 4 illustrates linkage between a downlink component carrier and an uplink component carrier in a multiple component carrier system according to the present invention;

FIG. 5 illustrates an example of a cell arrangement scenario according to the present invention;

FIG. 6 is a flowchart illustrating a method of performing uplink synchronization by user equipment (UE) according to an example of the present invention;

FIG. 7 is a flowchart illustrating a method of determining validity of a timing advance value by a UE according to an example of the present invention;

FIG. 8 is a view illustrating a method of determining validity of a timing advance value according to an example of the present invention;

FIG. 9 is a view illustrating a method of determining validity of a timing advance value according to another example of the present invention;

FIG. 10 is a view illustrating a method of determining validity of a timing advance value according to still another example of the present invention;

FIG. 11 is a flowchart illustrating a method of performing uplink synchronization by a base station according to an example of the present invention;

FIG. 12 is a block diagram illustrating a UE and a base station according to an example of the present invention;

FIG. 13 illustrates an example in which downlink control information (DCI) according to the present invention is mapped to an extended physical downlink control channel;

FIG. 14 illustrates another example in which the DCI according to the present invention is mapped to the extended physical downlink control channel;

FIG. 15 illustrates still another example in which the DCI according to the present invention is mapped to the extended physical downlink control channel;

FIG. 16 is a block diagram illustrating the structure of a medium access control (MAC) element according to an example of the present invention; and

FIG. 17 is a block diagram illustrating the structure of an MAC element according to another example of the present invention.

### DETAILED DESCRIPTION OF THE INVENTION

Hereinafter, in the specification, some embodiments are described in detail through exemplary drawings. In denoting the elements of the drawings by reference numerals, the same elements are denoted by the same reference numerals although the elements are displayed in different drawings. In addition, in describing the embodiments of the specification, when it is determined that detailed description of a related published structure or function may blur the subject matter of the specification, detailed description thereof will be omitted.

In addition, the specification relates to a wireless communication network. A work may be performed on the wireless communication network in a procedure of controlling a network and transmitting data in a system (for example, a base station) in charge of the corresponding wireless communication network or may be performed by a user equipment (UE) combined with the corresponding wireless network.

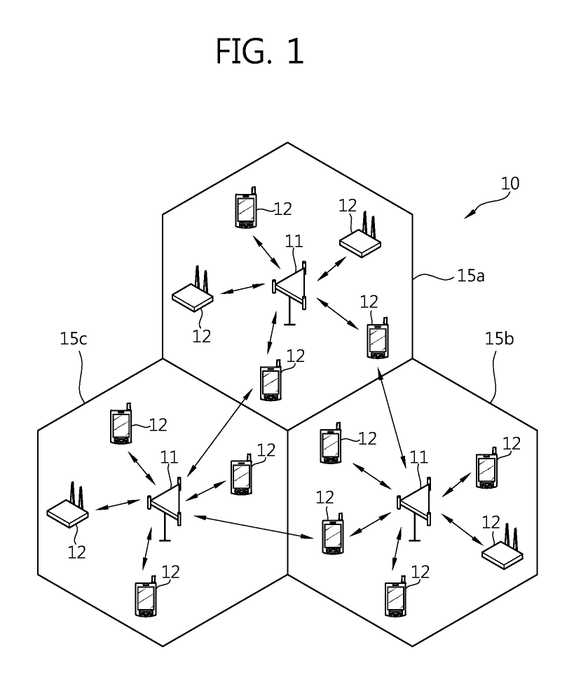

FIG. 1 illustrates a wireless communication system according to the present invention.

Referring to FIG. 1, a wireless communication system 10 is widely provided in order to provide various communication services such as voice and packet data. The wireless communication system 10 includes at least one base station (BS) 11 and a repeater (not shown). The base stations 11 provide communication services to specific cells 15a, 15b, and 15c. A cell may be divided into a plurality of regions (referred to as sectors).

In general, communication business operators install a plurality of base stations to support a wireless service on a desired service area. However, the wireless service may not be provided to some areas due to physiographic condition. The areas are referred to as shadow zones. The repeater is used in order to remove the shadow zones.

The repeater is divided into an analog repeater and a digital repeater. In the downlink operation of the analog repeater, the base station converts a processed digital signal into an analog signal to wiredly or wirelessly transmit the analog signal to the analog repeater. The analog repeater amplifies the signal received from the base station to transmit the amplified signal to a service area in which a UE to be served by the analog repeater exists. At this time, noise generated by the base station and interference and noise generated by wired/wireless channels between the base station and the repeater are amplified together with signals to be transmitted.

Therefore, quality of a signal is always deteriorated in comparison with quality of the signal initially transmitted from the base station, which is the same to an uplink. In addition, in the uplink, signals transmitted from a plurality of UEs in the service area of the analog repeater are received by the analog repeater. The analog repeater simply amplifies a plurality of signals to wiredly/wirelessly transmit the amplified signals to the base station. In addition, the base station may not distinguish UEs from each other by analog signals. Therefore, the base station may not determine which signal is received through the analog repeater and which signal is directly received from the UE to the base station among the signals received by the uplink.

In the digital repeater, in order to compensate for the disadvantage of the analog repeater, the base station wiredly (commonly, through optical cable) transmits a processed digital signal to the digital repeater. The digital repeater may be referred to as a remote radio head (RRH) in order to be distinguished from the analog repeater. Since the base station transmits digital data to the digital repeater, interference and noise generated by the analog base station may be removed and the base station may distinguish a signal received from the digital repeater from a signal received from the base station. According to the present invention, the analog repeater is referred to as a repeater.

A user equipment (UE) 12 may be fixed or movable and may be referred to as a mobile station (MS), a mobile terminal (MT), a user terminal (UT), a subscriber station (SS), a wireless device, a personal digital assistant (PDA), a wireless modem, and a handheld device. The base station 11 may be referred to as an evolved node B (eNB), a base transceiver system (BTS), an access point, a femto base station, a home node B, and relay. A cell is to be interpreted as indicating a partial region covered by the base station 11 and includes various coverage regions such as a megacell, a macrocell, microcell, a picocell, and a femtocell.

Hereinafter, a downlink means communication from the base station 11 to the UE 12 and an uplink means communication from the UE 12 to the base station 11. In the downlink, a transmitter may be a part of the base station 11 and a receiver may be a part of the UE 12. In the uplink, the transmitter may be a part of the UE 12 and the receiver may be a part of the base station 11. There are no limitations on a multiple access method applied to the wireless communication system. Various multiple access methods such as code division multiple access (CDMA), time division multiple access (TDMA), frequency division multiple access (FDMA), orthogonal frequency division multiple access (OFDMA), single carrier—FDMA (SC-FDMA), OFDM-FDMA, OFDM-TDMA, and OFDM-CDMA may be used. A time division duplex (TDD) method in which the transmission time of uplink transmission is different from the transmission time of downlink transmission or a frequency division duplex (FDD) method in which the frequency of the uplink transmission is different from the frequency of the downlink transmission may be used.

Carrier aggregation (CA) for supporting a plurality of carriers may be referred to as spectrum aggregation or bandwidth aggregation. Separate unit carriers bound by the carrier aggregation are referred to as component carriers (CC). Each of the component carriers is defined by bandwidth and a center frequency. The carrier aggregation is introduced to support increased throughput, to prevent cost from increasing due to introduction of a wideband radio frequency (RF) element, and to guarantee compatibility with an existing system. For example, when five component carriers are allotted as granularity in units of carriers having bandwidth of 20 MHz, bandwidth of 100 MHz may be maximally supported.

The carrier aggregation may be divided into contiguous carrier aggregation performed among continuous component carriers and non-contiguous carrier aggregation performed among non-continuous component carriers in a frequency region. The number of carriers aggregated between the downlink and the uplink may vary. The carrier aggregation in which the number of downlink component carriers is the same as the number of uplink component carriers is referred to as symmetric aggregation. The carrier aggregation in which the number of downlink component carriers is different from the number of uplink component carriers is referred to as asymmetric aggregation.

The magnitudes (that is, bandwidths) of the component carriers may vary. For example, when five component carriers are used to form a band of 70 MHz, a 5 MHz component carrier (carrier #0), a 20 MHz component carrier (carrier #1), a 20 MH component carrier (carrier #2), a 20 MHz component carrier (carrier #3), and a 5 MHz component carrier (carrier #4) may be used.

Hereinafter, a multiple component carrier system refers to a system for supporting the carrier aggregation. In the multiple component carrier system, the contiguous carrier aggregation and/or the non-contiguous carrier aggregation may be used or any of the symmetric aggregation and the asymmetric aggregation may be used.

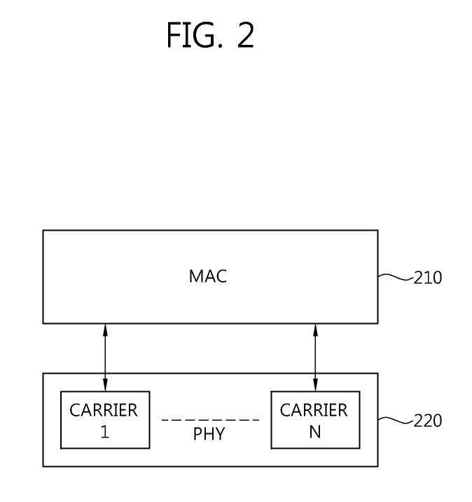

FIG. 2 illustrates a protocol structure for supporting multiple component carriers according to the present invention.

Referring to FIG. 2, a shared medium access control (MAC) element 210 manages a physical layer 220 in which a plurality of carriers are used. An MAC management message transmitted to a specific carrier may be applied to the other carriers. That is, the MAC management message may control the carriers including the specific carrier. The physical layer 220 may be operated by the TDD method and/or the FDD method.

In physical control channels used in the physical layer 220, a physical downlink control channel (PDCCH) provides resource allotment information of a paging channel (PCH) and a downlink shared channel (DL-SCH) and hybrid automatic repeat request (HARQ) information of the DL-SCH to the UE. The PDCCH may transport uplink grant that informs the UE of the resource allotment of the uplink transmission. A physical control format indicator channel (PCFICH) informs the UE of the number of OFDM symbols used for the PDCCHs and is transmitted every sub frame. A physical hybrid ARQ indicator channel (PHICH) transports an HARQ ACK/NAK signal in response to the uplink transmission. A physical uplink control channel (PUCCH) transports uplink control information such as HARQ ACK/NAK, scheduling request, and CQI on downlink transmission. A physical uplink shared channel (PUSCH) transports an uplink shared channel (UL-SCH). A physical random access channel (PRACH) transports a random access preamble.

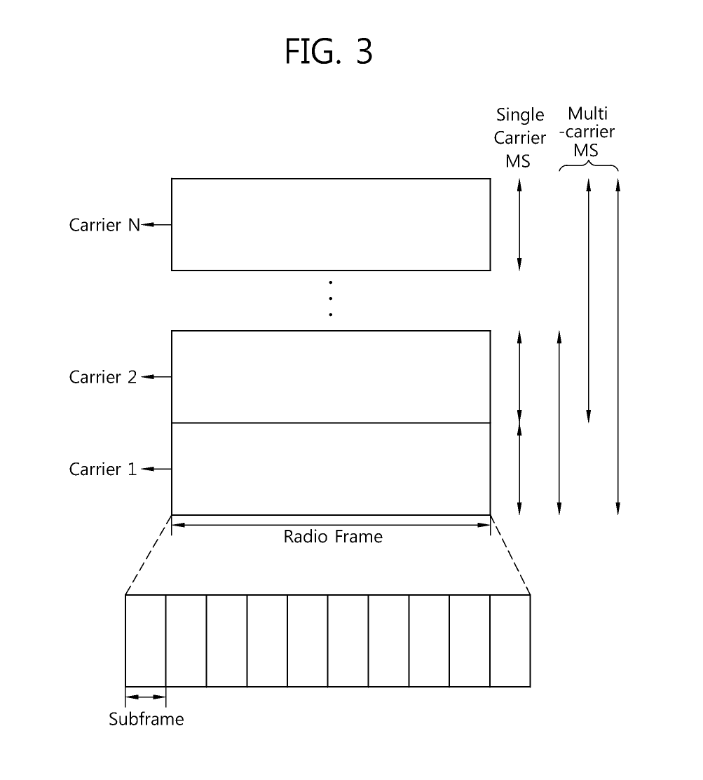

FIG. 3 illustrates an example of a frame structure for describing operations of the multiple component carriers according to the present invention.

Referring to FIG. 3, a frame includes ten sub-frames. A sub-frame includes a plurality of OFDM symbols. Each of the component carriers may have a control channel (for example, the PDCCH). Multiple component carriers may be contiguous to each other or may not be contiguous to each other. A UE may support one or more carriers in accordance with its ability.

A component carrier may be divided into a primary component carrier (PCC) and a secondary component carrier (SCC) in accordance with whether the component carrier is activated or not. The primary component carrier is always activated and the secondary component carrier is activated/deactivated in accordance with a specific condition. Activation means that transmission or reception of traffic data is performed or in a ready state. Deactivation means that transmission or reception of traffic data may not be performed and measurement or transmission/reception of minimum information may be performed. The UE may use only one primary component carrier or may use one or more secondary component carriers together with the primary component carrier. The UE may receive the primary component carrier and/or the secondary component carrier from a base station.

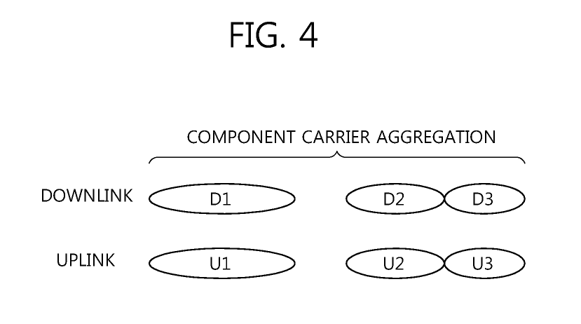

FIG. 4 illustrates linkage between a downlink component carrier and an uplink component carrier in a multiple component carrier system according to the present invention.

Referring to FIG. 4, for example, downlink component carriers D1, D2, and D3 are aggregated in a downlink and uplink component carriers U1, U2, and U3 are aggregated in an uplink. Here, Di is an index of a downlink component carrier and Ui is an index of an uplink component carrier (i=1, 2, and 3). The index does not coincide with the order of a component carrier or the position of the frequency band of the corresponding component carrier.

On the other hand, at least one downlink component carrier may be configured as a primary component carrier and the remaining downlink component carriers may be configured as secondary component carriers. In addition, at least one uplink component carrier may be configured as a primary component carrier and the remaining uplink component carriers may be configured as secondary component carriers. For example, D1 and U1 are primary component carriers and D2, U2, D3, and U3 are secondary component carriers.

Here, the index of the primary component carrier may be configured as 0 and one of the natural numbers excluding 0 may be the index of the secondary component carrier. In addition, the indexes of the downlink/uplink component carriers may be the same as the indexes of component carriers (or serving cells) including the corresponding downlink/uplink component carriers. In addition, in another example, only the component carrier index or the secondary component carrier index is configured and the downlink/uplink component carrier indexes included in the corresponding component carrier may not exist.

In the FDD system, a one-to-one establishment may be configured between the downlink component carriers and the uplink component carriers. For example, an establishment between D1 and U1, an establishment between D2 and U2, and an establishment between D3 and U3 may be configured, respectively. A UE configures an establishment between the downlink component carriers and the uplink component carriers through system information transmitted by a logic broadcast control channel (BCCH) or a UE dedicated radio resource control (RRC) message transmitted by a downlink control channel (DCCH). Such an establishment is referred to as a system information block 1 (SIB1) establishment or a system is information block 2 (SIB2) establishment. The establishment may be cell specifically configured or may be UE specifically configured. For example, the primary component carrier may be cell specifically configured and the secondary component carrier may be UE specifically configured.

Here, a one-to-one establishment may be configured between the downlink component carriers and the uplink component carriers or a 1:n or n:1 establishment may be configured.

A primary serving cell means one serving cell that provides security input and non-access stratum (NAS) mobility information in an RRC establishment or re-establishment state. In accordance with capability of the UE, at least one cell may form a set of serving cells together with the primary serving cell. The at least one cell is referred to as a secondary serving cell.

Therefore, the set of the serving cells configured for one terminal may include only one primary serving cell or a primary serving cell and at least one secondary serving cell.

The downlink component carrier corresponding to the primary serving cell is referred to as a downlink primary component carrier (DLPCC) and the uplink component carrier corresponding to the primary serving cell is referred to as an uplink primary component carrier (ULPCC). In addition, in the downlink, the component carrier corresponding to the secondary serving cell is referred to as a downlink secondary component carrier (DLSCC) and, in the uplink, the component carrier corresponding to the secondary serving cell is referred to as an uplink secondary component carrier (ULSCC). Only the downlink component carrier may correspond to one serving cell. The DLCC and the ULCC may correspond to one serving cell.

Therefore, in the carrier system, that communications between the UE and the base station are performed through the DLCC or the ULCC is equal to that communications between the UE and the base station are performed through the serving cells. For example, in a method of performing random access according to the present invention, that the UE transmits a preamble using the ULCC is equal to that the UE transmits a preamble using the primary serving cell or the secondary serving cell. In addition, that the UE receives downlink information using the DLCC is equal to that the UE receives downlink information using the primary serving cell or the secondary serving cell.

On the other hand, the primary serving cell and the secondary serving cell have the following characteristics.

First, the primary serving cell is used for transmitting the PUCCH. On the other hand, the secondary serving cell may not transmit the PUCCH, however, may transmit partial control information of information in the PUCCH through the PUSCH.

Second, meanwhile the primary serving cell is always activated, the secondary serving cell is activated/deactivated in accordance with a specific condition. In the specific condition, the activation/deactivation MAC control element (CE) message of the base station is received or a deactivation timer in the UE expires.

Third, the RRC re-establishment is triggered when the primary serving cell experiences radio link failure (RLF), however, is not triggered when the secondary serving cell experiences the RLF. RLF is not defined for the secondary serving cell. The RLF is generated when a downlink capability is maintained to be no more than a threshold value for no less than a predetermined time or when a random access procedure fails by the number of times no less than the threshold value.

Fourth, the primary serving cell may be changed by a handover procedure accompanied with a security key changing procedure or a random access procedure. In a contention resolution (CR) message, only a physical downlink control channel (hereinafter, referred to as PDCCH) that indicates CR is to be transmitted through the primary serving cell and CR information may be transmitted through the primary serving cell or the secondary serving cell.

Fifth, NAS information is received through the primary serving cell.

Sixth, the primary serving cell always includes the DLPCC and the ULPCC that make a pair.

Seventh, UEs may configure different CCs as primary serving cells.

Eighth, procedures of reconfiguring, adding, and removing the secondary serving cell may be performed by an RRC layer. In adding a new secondary serving cell, RRC signaling may be used for transmitting system information of a dedicated secondary serving cell.

Ninth, the primary serving cell may provide the PDCCH (for example, downlink allotment information or uplink grant information) allotted to a UE-specific search space configured in order to transmit control information to a specific UE in a region where the control information is transmitted and the PDCCH (for example, system information (SI), random access response (RAR), or transmit power control (TPC)) allotted to a common search space configured in order to transmit the control information to all of the UEs in the cell or a plurality of UEs that satisfy a specific condition. On the other hand, the secondary serving cell may configure only the UE-specific search space. That is, since the UE may not confirm the common search space through the secondary serving cell, control information items transmitted only through the common search space and data information items indicated by the control information items may not be received.

The spirit of the present invention related to the characteristics of the primary serving cell and the secondary serving cell is not limited to the above. The above is only an example and more examples are available.

In a wireless communication environment, while a radio wave is transmitted from a transmitter to a receiver, propagation delay is generated. Therefore, although the transmitter and the receiver correctly know the time at which the radio wave is transmitted from the transmitter, the time at which a signal reaches the receiver is affected by transmission and reception periods and a peripheral propagation environment and changes in accordance with time when the receiver moves. When the receiver may not correctly know the timing at which the signal transmitted by the transmitter is received, the signal is not received or, although the signal is received, a distorted signal is received so that a communication may not be performed.

Therefore, in the wireless communication system, regardless of the downlink/uplink, synchronization between the base station and the UE must be performed in order to receive an information signal. Synchronization includes frame synchronization, information symbol synchronization, sampling period synchronization, etc. The sampling period synchronization is to be basically obtained in order to distinguish physical signals from each other.

Downlink synchronization is obtained by the UE based on a signal transmitted by the base station. The base station transmits a mutually arranged specific signal so that the downlink synchronization is easily obtained by the UE. The UE is to correctly know the time at which the specific signal is transmitted by the base station. In the downlink, since one base station simultaneously transmits the same synchronizing signal to the plurality of UEs, the UEs may independently obtain synchronization.

In the uplink, the base station receives signals transmitted from the plurality of UEs. When the distances between the UEs and the base station are different from each other, the signals received by the base station have different transmission delay times. When the UEs transmit uplink information based on the obtained downlink synchronization, the base station receives information on the UEs at different times. In such a case, the base station may not obtain synchronization based on one UE. Therefore, in obtaining uplink synchronization, different procedures from the procedures of downlink synchronization are required.

A random access procedure is performed in order to obtain the uplink synchronization. In the random access procedure, the UE adjusts uplink timing based on a value in a time advanced field or a timing advance value included in a random access response provided by the base station to obtain the uplink synchronization. The timing advance value is information of quantitatively displaying the time to be adjusted in order to perform the uplink synchronization in a specific secondary serving cell based on the downlink synchronization timing of a timing reference cell when random access of the corresponding UE is attempted. When a predetermined time passes after obtaining the uplink synchronization based on the timing advance value, the obtained uplink synchronization may not be valid due to a change in an external wireless channel such as the movement of the UE. Therefore, a time alignment timer (TAT) that may be formed by the base station in order to determine whether the obtained uplink synchronization is valid and that may start the random access procedure by the UE in order to obtain the uplink synchronization at expiration is configured in the UE. When the TAT is running, the UE determines that the uplink synchronization is performed between the UE and the base station. When the TAT expires or does not operate, it is determined that synchronization is not performed between the UE and the base station and the terminal does not perform uplink transmissions excluding transmission of a random access preamble.

In order for the UE to transmit uplink signals excluding the random access preamble, the UE is to obtain a valid timing advance value for the ULCC corresponding to the corresponding serving cell. When the valid timing advance value for the ULCC is obtained, the UE may periodically transmit an uplink signal such as a sounding reference signal (SRS) or channel state information (CSI) that is formed previously formed by the base station to the ULCC without special indication of the base station. In addition, a signal such as the non-periodical SRS and a data channel such as the PUSCH that are indicated by the base station may be transmitted. Here, the SRS may be a basic reference signal by which the base station measures the uplink synchronization in order to update the timing advance value. The base station may determine whether the timing advance value secured for the ULCC is valid or is to be updated in real time based on the uplink signal. When the timing advance value is to be updated, the base station may inform the UE of the updated timing advance value through a MAC CE.

The uplink signal may be transmitted only when the serving cell including the ULCC is activated. To the contrary, when the secondary serving cell is deactivated, the UE may not transmit the uplink signal through the ULSCC corresponding to the secondary serving cell. When the uplink signal is not transmitted since the secondary serving cell is deactivated, validity of the timing advance value is not guaranteed. Therefore, in a state where the validity of the pre-configured timing advance value is not guaranteed for a predetermined time, when the deactivated secondary serving cell is activated by an activation indicator, the UE needs to determine whether the timing advance value of the TAG to which the pre-configured activated secondary serving cell belongs is valid.

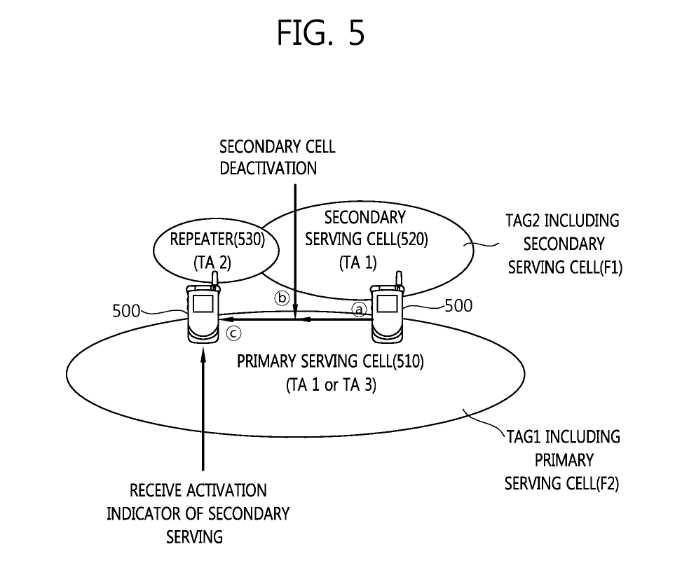

FIG. 5 illustrates an example of a cell arrangement scenario according to the present invention.

Referring to FIG. 5, a primary serving cell 510 that is a frequency F2 and a secondary serving cell 520 that is a frequency F1 are configured in an UE 500 and the UE 500 moves from a position \textcircled{a} to a position \textcircled{c} through a position \textcircled{b}. Vicinity of the position \textcircled{c} is an area served by a repeater 530. The UE 500 performs a communication in the position \textcircled{c} by the repeater 530.

In the position \textcircled{a}, the primary serving cell 510 and the secondary serving cell 520 configured in the UE 500 are activated. The primary serving cell 510 belongs to a first TAG TAG1 having a timing advance value TA1 or TA3. The secondary serving cell 520 belongs to a second TAG TAG2 having the timing advance value TA1. The TAG is a set of serving cells having the same timing advance value (that is, requiring the same amount of uplink timing adjustment). The TAG is a UE-specifically formed parameter. That is, the same serving cell may belong to the TAG1 for a UE1 and may belong to the TAG2 for a UE2. The TAG may be dynamically changed for the UEs.

In the position \textcircled{a}, since the secondary serving cell 520 is activated, the UE may periodically transmit the SRS for the band of the frequency F1. At this time, the base station receives the SRS to continuously monitor a change in the timing advance value TA1. The base station determines the validity of the timing advance value so that the UE 500 may change the timing advance value for the band of the frequency F1 using an update procedure if necessary. The update procedure includes a random access procedure or a procedure of transmitting a time advance command MAC CE message.

Let's assume that the secondary serving cell 520 is deactivated when the UE 500 reaches the position \textcircled{b}. When all of the secondary serving cells in the second TAG TAG2 are deactivated, the UE 500 may not perform SRS transmission and other uplink transmissions through any serving cell in the second TAG. The base station may not determine validity of the timing advance value TA1 of the second TAG. At this time, a TAT for the second TAG is continuously running. The TAT is introduced in order to determine the validity of the timing advance value. The UE 500 is informed of the expiration time of the TAT by the base station. The expiration time of the TAT is determined by the base station based on the movement speed of the UE 500 that is estimated by the base station.

Let's assume that the secondary serving cell 520 is activated again when the UE 500 reaches the position \textcircled{c}. At this time, since the UE 500 enters a service area for the band of the frequency F1 of the repeater 530, the uplink and the downlink of the secondary serving cell in the second TAG TAG2 perform communications with the repeater 530. At this time, the timing advance value TA2 is to be applied to synchronization of uplink transmission signals through the secondary serving cell of the UE 500 for the repeater 530 in the position \textcircled{c}. Since the TAT for the second TAG TAG2 is continuously running, the timing advance value TA1 is is valid in the uplink synchronization for the UE 500. Therefore, validity of a rapid change in the timing advance value such as a change in the installation environment of the repeater 530 in accordance with the movement of the UE may not be guaranteed by the TAT. For example, when the UE 500 verifies the validity of the timing advance value only by the TAT, the UE 500 performs the uplink transmission in accordance with the uplink synchronization in accordance with the timing advance value TA1 that is not valid to interfere the uplink signals of all of the UEs that directly communicate with the base station using the band of the frequency F1 as well as the uplink signals of the other UEs that communicate with the base station through the repeater 530. Therefore, when the secondary serving cell is activated, it is necessary for the UE to determine whether the pre-configured timing advance value is valid in consideration of the timing advance value in accordance with the changed environment of the repeater.

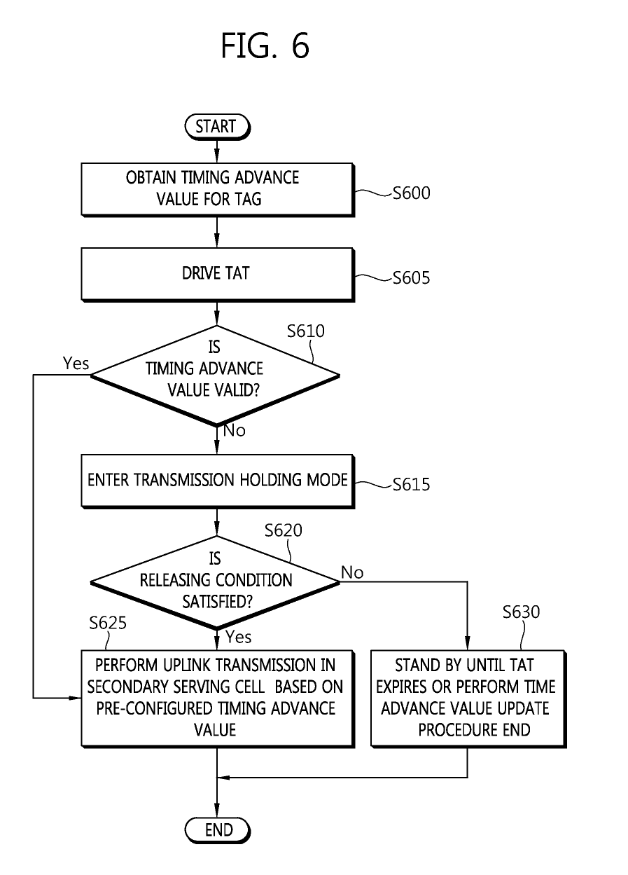

FIG. 6 is a flowchart illustrating a method of performing uplink synchronization by a user equipment (UE) according to an example of the present invention.

Referring to FIG. 6, an UE obtains a timing advance value through one of secondary serving cells in a timing advance group (TAG) formed of only the secondary serving cells S600. The UE may obtain the timing advance value of the TAG by a random access procedure performed by the secondary serving cell. Here, the secondary serving cell may be a secondary serving cell including a timing reference serving cell (or DLCC) as a reference for downlink timing as a reference for applying the timing advance value of the TAG among the secondary serving cells in the TAG. At this time, the random access procedure may be induced by the indication of the base station. The UE adjusts uplink timing in the secondary serving cell based on the timing advance value.

The UE drives a TAT S605. The TAT concretely operates as follows.

When the UE receives a time advance command (TAC) from the base station through an MAC control element, the UE applies the timing advance value indicated by the received TAC to uplink synchronization. The UE starts or initiates the TAT.

In the case where the UE receives the TAC from the base station through a random access response message, (a) when the random access response message is not selected by the MAC layer of the UE, the UE applies the timing advance value indicated by the TAC to the uplink synchronization and starts or initiates the TAT. In the case where the UE receives the TAC from the base station through the random access response message, (b) when the random access response message is selected by the MAC layer of the UE and the TAT does not operate, the UE applies the timing advance value indicated by the TAC to the uplink synchronization and starts the TAT. When contention is not removed in the random access procedure, the UE stops the TAT. In the other cases than (a) and (b), the UE ignores the TAC.

When the TAT expires, the UE flushes data stored in all of uplink HAR buffers. The UE may maintain the structure of an SRS. SRS of type 0 (periodical SRS) may be released and SRS of type 1 (non-periodical SRS) may not be released. In addition, the UE clears all of the formed uplink resource allotments.

The UE determines whether the timing advance value is valid S610. The validity of the timing advance value is related to downlink timing jump. For example, it may be determined that the timing advance value is not valid when the downlink timing jump is generated and that the timing advance value is valid when the downlink timing jump is not generated. The downlink timing jump means that a change in downlink timing in a short period is large. That is, a minute change in which the UE may automatically adjust uplink timing is not included in the downlink timing jump. The validity of the timing advance value is the same as the validity of the uplink timing.

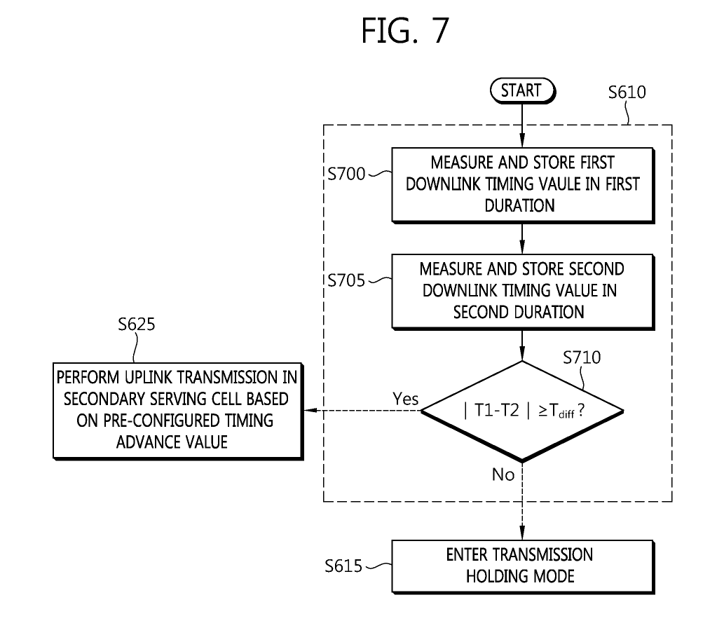

For example, in determining the validity of the timing advance value, downlink timing values measured at different timings are compared with each other and changes in the downlink timing values are calculated, which will be described with reference to FIGS. 7 to 9. First, referring to FIG. 7, the UE measures and stores a first downlink timing value T1 based on the downlink timing reference of the secondary serving cell in a first duration S700 and measures and stores a second downlink timing value T2 based on the downlink timing reference of the secondary serving cell in a second duration S705. The downlink timing may be defined as the time at which an initially sensed time path of a corresponding downlink frame is received from a reference cell.

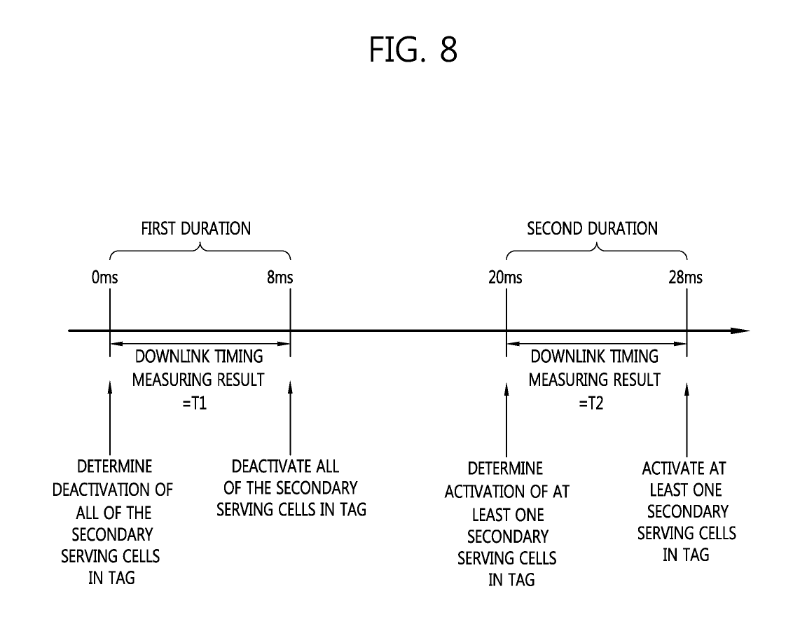

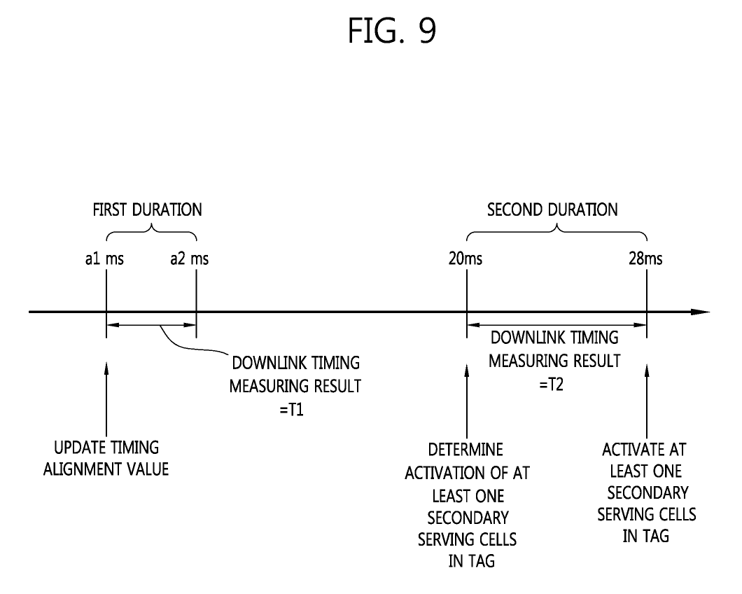

The first duration may be defined as from the time (for example, Oms) at which deactivation of all of the serving cells in the TAG including the secondary serving cell is determined to the time (for example, 8 ms) at which all of the serving cells are deactivated as illustrated in FIG. 8. The first duration may be defined as the time (for example, a1 ms) at which the timing advance value is finally updated as illustrated in FIG. 9 for the TAG through the random access response message or the MAC CE for the TAC or may be defined as from the a1 to a specific time (for example, a2 ms).

The second duration may be defined as from the time (for example, 20 ms) at which activation of at least a serving cell in the TAG is determined to the time (for example, 28 ms) at which at least a serving cell is activated.

The UE determines whether the absolute value (that is, a change in the downlink timing value in accordance with time) of a difference between T1 and T2 is no less than a threshold value S710. When it is determined that the absolute value is no less than the threshold value, the UE determines that the timing advance value (or the adjusted uplink timing) is valid. When it is determined that the absolute value is less than the threshold value, the UE determines that the timing advance value (or the adjusted uplink timing) is not valid. Here, the threshold value configured by the base station may be indicated as lower layer signaling such as the PDCCH and may be indicated as upper layer signaling such as the MAC CE or the RRC message. An experimentally certified fixed value may be stored by the UE in a memory to be used.

Since the threshold value is a change in the downlink timing value, in principle, it is most correct to determine the validity of the timing advance value by the timing advance value. For this purpose, the UE transmits an uplink signal and receives a new timing advance value from the base station to compare the new timing advance value with a previous timing advance value. It is contradictory to perform such an operation in a state where the uplink synchronization is not performed. Therefore, the UE preferably determines the validity of the timing advance value in accordance with the downlink timing value that may be obtained thereby. In order to increase the correctness of determination of the validity of the timing advance value, a valid threshold value is preferably designed to be related to the timing advance value.

For this purpose, the valid threshold value may be interlocked with an error correcting range of the timing advance value. That is, the valid threshold value is to be defined in a range where the timing advance value may be validly corrected. For example, in the level of the timing advance value, when Tq is an automatic error correcting range, the automatic error correcting range is converted into the level of the downlink timing value so that the valid threshold value corresponds to Tq. The function relationship illustrated in the following equation may be configured between the valid threshold value and the timing advance value.

Tth=f(Tq) [EQUATION 1]

Referring to the equation 1, f(x) is a function of converting the timing advance value x into the level of the valid threshold value about the downlink timing. Tq is the maximum range in which the UE may autonomously correct the error of the uplink timing. Tq=k*Ts, k=2, 4, 8, and 16, and Ts is a sampling period. Tq may be defined by the following table in accordance with the downlink bandwidth of the serving cell configured in the UE.

Here, Tq may include a value corrected by a single correcting operation or a plurality of correcting operations.

TABLE 1

| Downlink bandwidth (MHz) | Tq |
|---|---|
| 1.4 | 16 * Ts |
| 3 | 8 * Ts |
| 5 | 4 * Ts |
| ≧10 | 2 * Ts |

For example, let's assume that f(x)=0.5×, Ts=0.0325 μs, and the downlink bandwidth is 5 MHz. Then, Tq=4*0.0325=0.13 μs and Tth=f(0.13)=0.5*0.13=0.065 μs. Therefore, the UE may determine that a validity loss condition is satisfied when the absolute value of the difference between T1 and T2 is no less than 0.065 μs.

In another example, the UE may correct the timing advance value in accordance with the following regulations. Hereinafter, Ts is a sampling period and Tq is a basic adjustment unit for voluntary correction.

The maximum timing advance correcting value that may be changed in the single correcting operation is Tq.

The minimally aggregated correcting ratio by second is 7*Ts.

The maximally aggregated correcting ratio by 200 ms is Tq.

Here, the aggregated value may be defined as a value obtained by obtaining the absolute values of the correcting values of the timing advance value generated by the voluntary correcting operation of the UE and by adding the absolute values to each other. The aggregate value may be defined as a value obtained by adding the correcting values of the timing advance value generated by the voluntary correcting operation of the UE to each other and by obtaining the absolute value.

The UE may correct the timing advance value based on the Tq value and the timing advance value correcting operation regulation of the UE within the following Te value when an error (a difference) in the timing advance value generated by reference timing (that is, downlink timing) at the timing when the timing advance value TA of a specific TAG is obtained and the reference timing (that is, the downlink timing) of the specific TAG of the current UE is larger than the Te value of the following table 2.

TABLE 2

| Downlink bandwidth (MHz) | Te |
|---|---|
| 1.4 | 24 * Ts |
| ≧3 | 12 * Ts |

Therefore, the valid threshold value may be defined by the maximally aggregated correcting ratio value per unit time (such as 2 seconds or 200 ms)+the Te value or the downlink timing difference value corresponding to the above sum.

For example, when the unit time is 200 ms, the UE may correct the timing advance value by Tq based on the maximally aggregated correcting ratio. At this time, when the error generated by the reference timing (that is, the downlink timing) at the timing when the timing advance value TA of the specific TAG and the reference timing (that is, the downlink timing) of the specific TAG is no less than Te+Tq, it is determined that there is a problem in the uplink synchronization. That is, the timing advance value may be corrected by Tq for 200 ms that is the unit time. However, the error of the timing advance value for Te exists. Therefore, the UE may confirm a problem in the uplink synchronization. In this case, the valid threshold value is the downlink timing difference value corresponding to the timing advance value error per the unit time (200 ms) Te+Tq or the downlink timing difference value corresponding to the timing advance value error.

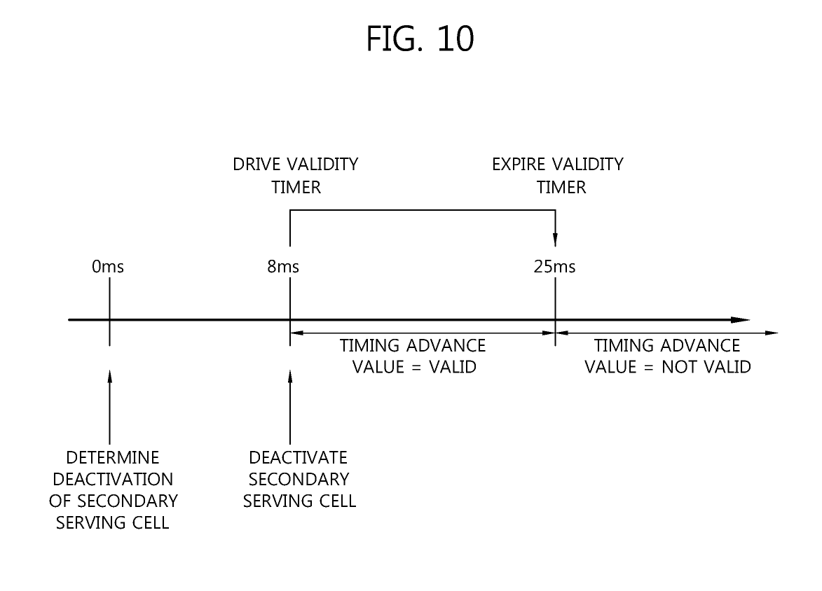

In another example, in determining the validity of the timing advance value, it is determined whether the validity timer expires or not. The validity timer is used for the UE determining whether a pre-configured timing advance value is valid or not. The validity timer is driven by deactivation of the secondary serving cell and expires when expiration time Δt passes. On the other hand, when the secondary serving cell is activated while the validity timer is running, the validity timer may be stopped. A method of determining the validity of the timing advance value based on the validity timer will be described with reference to FIG. 10. Referring to FIG. 10, the timing at which the validity timer is driven may be the time (for example, 0 ms in the drawing) at which the deactivation of the secondary serving cell is determined, the time at which a deactivating timer driven by the UE after the activating time expires, or the time (for example, 8 ms in the drawing) at which the UE actually starts a deactivation operation. When the validity timer expires at 25 ms, the UE determines that the timing advance value is not valid further. Before the validity timer expires, the UE determines that the timing advance value is still valid.

In still another example, in determining the validity of the timing advance value, it is determined whether the TAT defined by each TAG expires. For example, the UE determines that the timing advance value is not valid when the TAT expires and the UE determines that the timing advance value is valid before the TAT expires. When the TAT expires so that the timing advance value is not valid, a determined TAT expiring operation in the corresponding TAT is performed.

Referring to FIG. 6, when it is determined in S610 that the timing advance value is not valid at the timing when the TAT does not expire, the UE enters a transmission stop mode in which the uplink transmission is held S615. In the transmission holding mode, the UE does not perform any uplink transmission for activated serving cells in the TAG. For example, the uplink transmission includes periodical SRS transmission (type 0 SRS), periodical CQI transmission (periodic CSI reporting), or transmission of a scheduled signal.

In S610, when it is determined that the timing advance value is not valid at the timing when the TAT does not expire, the TAT in the corresponding TAG may forcibly expire.

In S610, when it is determined that the timing advance value is not valid at the timing when the TAT does not expire, the TAT of the corresponding TAG may be forcibly stopped. The TAT of the corresponding TAG may be forcibly stopped to be reset.

The TAT of each TAG in the UE is to be continuously initiated not to be expired by the base station. Therefore, the base station continuously transmits a TAC MAC CE so that the TAT does not expire. In a conventional communication system where component carrier aggregation is not supported, concepts of activation/deactivation of the serving cells are not defined. Therefore, when the TAT expires, a problem is generated in wireless communications for the downlink transmission between the base station and the UE so that normal data transmission and reception may not be performed. The UE may consider that a problem is generated in wireless communications between the UE and the base station based on the expiration of the TAT defined in such an assumption.

The expiration of the TAT is equal to the expiration of the TAT in the TAG including the primary serving cell. Therefore, as described above, an operation of initializing resources formed to transmit partial uplink transmission for all of the serving cells when the TAT in the TAG including the primary serving cell expires and for the serving cells in a corresponding TAG when the TAT in the TAG that does not include the primary serving cell expires is defined. According to the present invention, the situation in which there is no problem in receiving downlink data by the UE like in the downlink timing jump in the TAG that does not include the primary serving cell. That is, the UE does not need to perform an operation when the TAT expires.

Therefore, in the embodiment of the present invention, the TAT is stopped so that the UE does not perform an operation when the TAT expires. When the TAT is stopped, unlike in a case where the TAT expires, only the uplink transmission of the serving cells in the corresponding TAG is stopped.

When the UE determines that the timing advance value is not valid and enters the transmission holding mode in which the uplink transmission is held, the UE determines whether a releasing condition in which the transmission holding mode is released is satisfied S620. The releasing condition may be defined as initiating the held uplink transmission of the UE. In an example, in the releasing condition, uplink grant that indicates resources for the uplink transmission is received from the base station. The uplink grant is mapped to the PDCCH as downlink control information (DCI) to be transmitted to the UE. The DCI may include an uplink or downlink resource allotting field, an uplink transmission power control command field, a control field for paging, and a control field for indicting a RA response.

The purpose of the DCI varies with the format of the DCI and the field defined by the DCI varies with the format of the DCI. Table illustrates DCI in accordance with various formats.

TABLE 1

| DCI format | Description |
|---|---|
| 0 | Used for scheduling PUSCH |
| 1 | Used for scheduling one PDSCH codeword |
| | in one cell |
| 1A | Used for compactly scheduling one PDSCH |
| | codeword in one cell and for a random |
| | access procedure initialized by a PDCCH |
| | command |
| 1B | Used for compactly scheduling one PDSCH |
| | codeword in one cell using precoding |
| | information |
| 1C | Used for informing simple scheduling of |
| | one PDSCH codeword and a change in |
| | MCCH |
| 1D | Used for compactly scheduling one PDSCH |
| | codeword in one cell including precoding |
| | and power offset information |
| 2 | Used for performing PDSCH scheduling on |
| | UE in a spatial multiplexing mode |
| 2A | Used for performing PDSCH scheduling on |
| | UE in a large delay CDD mode |
| 2B | Used for transmission mode 8 (double layer |
| | transmission) |
| 2C | Used for transmission mode 9 (multiple |
| | layer transmission) |
| 3 | Used for transmitting a TPC command for |
| | PUCCH and PUSCH including power |
| | adjustment of two bits |
| 3A | Used for transmitting the TPC command for |
| | the PUCCH and the PUSCH including |
| | power adjustment of a single bit |
| 4 | Used for scheduling the PUSCH (uplink |
| | grant), in particular, for performing the |
| | PUSCH scheduling on UE in the spatial |
| | multiplexing mode |

Referring to TABLE 1, DCI formats 0 and 4 are uplink grants. DCI format 1 for scheduling one PDSCH codeword, DCI format 1A for compactly scheduling one PDSCH codeword, DCI format 1C for very compactly scheduling DL-SCH, DCI format 2 for scheduling the PDSCH in a closed-loop spatial multiplexing mode, DCI format 2A for scheduling the PDSCH in an open-loop spatial multiplexing mode, and DCI formats 3 and 3A for transmitting the TPC command for an uplink channel exist. The fields of the DCI are sequentially mapped to n information bits a₀ to aₙ₋₁. For example, when the DCI is mapped to information of 44 bits, the fields of the DCI are sequentially mapped to a₀ to a₄₃. The DCI formats 0, 1A, 3, and 3A may have the same payload magnitude.

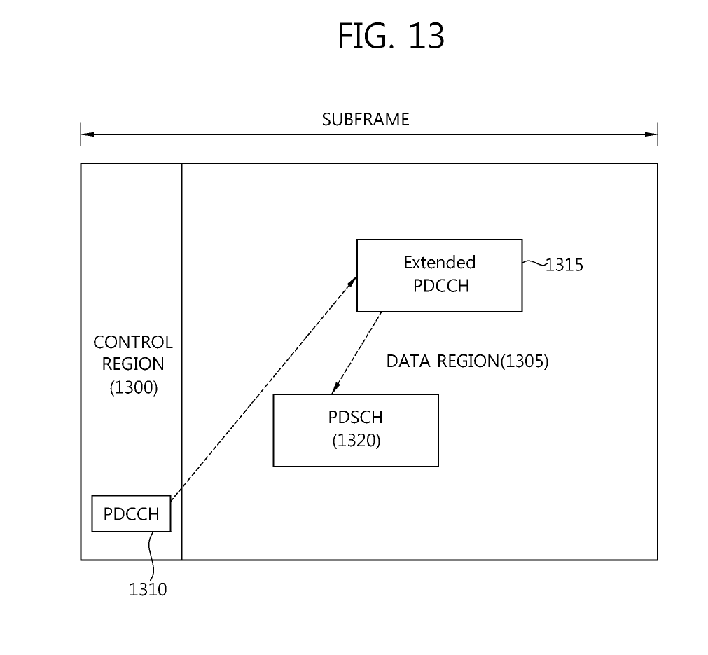

The DCI may be transmitted through a lower layer control channel defined by an extended PDCCH (EPDCCH). The EPDCCH is formed of a pair of resource blocks (RB). Here, the pair of RBs is defined as RBs for two slots that form one sub-frame. When the RBs make a pair, the pair of RBs is defined. The RBs of the pair of RBs may not be formed of slots having the same time. In addition, the pair of RBs may be formed of RBs that exist in the same frequency band and may be formed of RBs that exist in different frequency bands, which will be described with reference to FIGS. 13 to 15.

FIG. 13 illustrates an example in which downlink control information (DCI) according to the present invention is mapped to an extended physical downlink control channel.

Referring to FIG. 13, a downlink sub-frame includes a control region 1300 and a data region 1305. A PDCCH 1310 is mapped to the control region 1300. In a time region, the downlink sub-frame has a length of two to four OFDM symbols. An EPDCCH 1315 and a PDSCH 1320 are mapped to the data region 1305. In an indication relationship between downlink physical channels, the PDCCH 1310 indicates a region to which the EPDCCH 1315 is transmitted and the EPDCCH 1315 indicates the PDSCH 1320 including actually transmitted user information. At this time, the EPDCCH 1315 is limited to the resource indicated by the PDCCH1310 to be mapped.

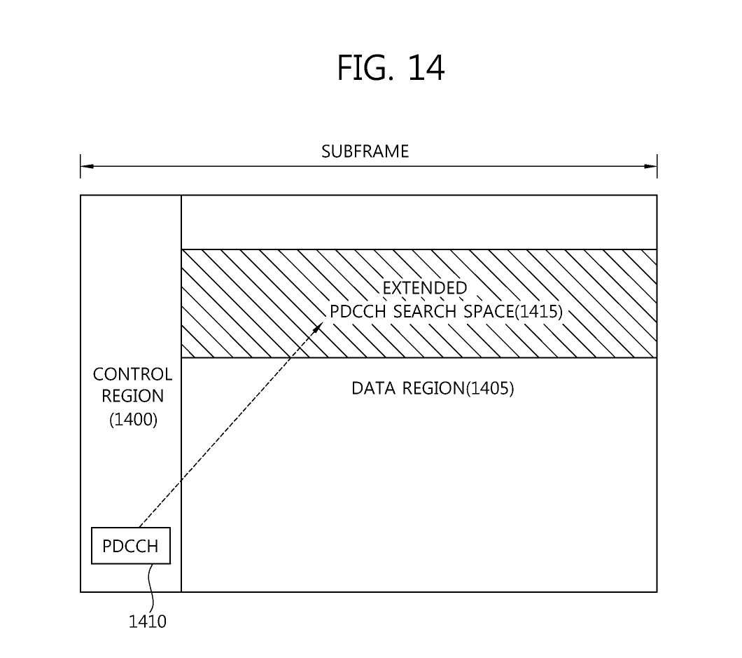

FIG. 14 illustrates another example in which the DCI according to the present invention is mapped to the extended physical downlink control channel.

Referring to FIG. 14, a PDCCH 1410 mapped to a control region 1400 indicates a search space 1415 of the EPDCCH mapped to a data region 1405. A UE must detect the EPDCCH from the search space 1415 of the EPDCCH using a data detecting method based on a blind decoding method used for receiving the PDCCH 1410, that is, a data detecting method based on a cyclic redundancy check (CRC) method.

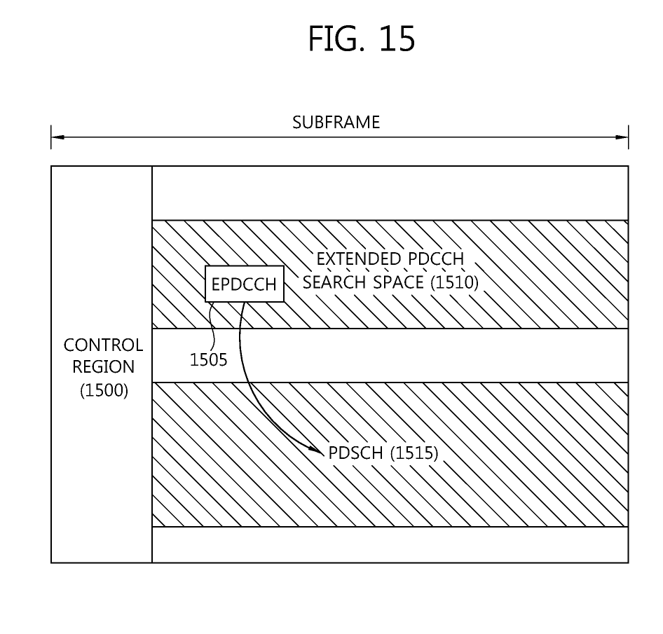

FIG. 15 illustrates still another example in which the DCI according to the present invention is mapped to the extended physical downlink control channel.

Referring to FIG. 15, an EPDCCH 1505 exists in PDSCH regions 1510 and 1515 regardless of a PDCCH. In information on a search space 1510 of the EPDCCH, information on different search spaces (for example, search space bandwidth information) is provided to the UEs in an upper layer RRC or information on a search space shared by a plurality of UEs is provided by an RRC signaling or broadcasting method. Here, a control region 1500 may not exist, that is, may be removed.

In this case, the UE must blind decode the search space 1510 of the EPDCCH in order to obtain the EPDCCH 1505. When the search space of the EPDCCH is 1, that is, when the search space 1510 of the EPDCCH is defined as a space to which only one EPDCCH may be mapped, a method of determining whether the EPDCCH of each UE is received by a data detecting method using C-RNT1 allotted to the UE may be used.

The base station determines whether the UE receives the EPDCCH 1505 or the PDCCH from a corresponding serving cell, which may be performed on the serving cells through upper layer (RRC) signaling.

Referring to FIG. 6, in S620, in the releasing condition, information of requesting the UE to transmit SRS or CSI is received from the base station. Information of requesting the UE to transmit the SRS or the CSI may be included in the DCI.

The following table illustrates contents indicated by SRS request information items of one bit. When an SRS request value is 1, the releasing condition is satisfied.

TABLE 3

| SRS request value | Indication content |
|---|---|
| 0 | No type 1 SRS request |
| 1 | Type 1 SRS request |

When a plurality of type 1 SRSs are formed through the RRC signaling, an SRS request indicator may be formed of two bits. The following table illustrates contents indicated by SRS request information items of two bits. Here, the two bit indicator is used only for the DCI format 4.

TABLE 3

| SRS request value | Indication content |
|---|---|
| 00 | No type 1 SRS request |
| 01 | First set type 1 SRS request |
| 10 | Second set type 1 SRS request |
| 11 | Third set type 1 SRS request |

The following table illustrates contents indicated by CSI items of two bits. When the CSI request values are 01, 10, and 11, the releasing condition is satisfied.

TABLE 4

| CSI request value | Indication content |
|---|---|
| 00 | There is no trigger of a non-periodical CSI |
| | report |
| 01 | Trigger of a non-periodical CSI report on a |
| | serving cell |
| 10 | Trigger of a CSI report on a serving cell of |
| | a first cell set configured by an upper layer |
| 11 | Trigger of a CSI report on a serving cell of |
| | a second cell set configured by an upper |
| | layer |

Referring to the table 4, when the value of CSI request information is 01, a non-periodical CSI report on a serving cell is triggered. In addition, when the values of CIS request information items are 10 and 11, CSI reports on serving cells of first and second cell sets are triggered. Here, the cell set indicates a set including at least one serving cell configured by an upper layer in the UE. The value of the CSI request of one bit may be defined as the trigger of the non-periodical CSI report when the value is 1 and may be defined as no trigger of the non-periodical CSI report when the value is 0.

In another example, in the releasing condition, the timing advance value of a corresponding TAG may be received from the base station.

In S620, when the releasing condition is satisfied, the UE releases the transmission holding mode and performs the uplink transmission in the secondary serving cell based on a pre-configured timing advance value or a newly received timing advance value S625, which is because the base station guarantees the validity of the currently secured timing advance value. Determination of the base station is reliable. Therefore, when the UE determines that the pre-configured timing advance value is not valid, although the UE enters the transmission holding mode based on the determination, the UE ignores its own determination to release the transmission holding mode in accordance with the indication of the base station. In this case, the UE does not need to perform an additional procedure (for example, a random access procedure) for updating the pre-configured timing advance value to the new timing advance value and may prevent delay from being generated due to the additional procedure.

When the releasing condition is not satisfied in S620, the UE stands by until the TAT that indicates the valid period of the timing advance value expires or performs a timing advance value updating procedure S630.

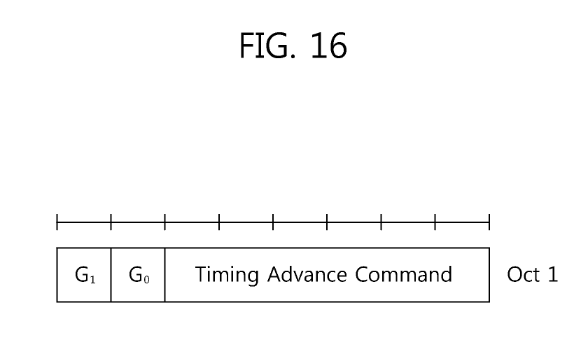

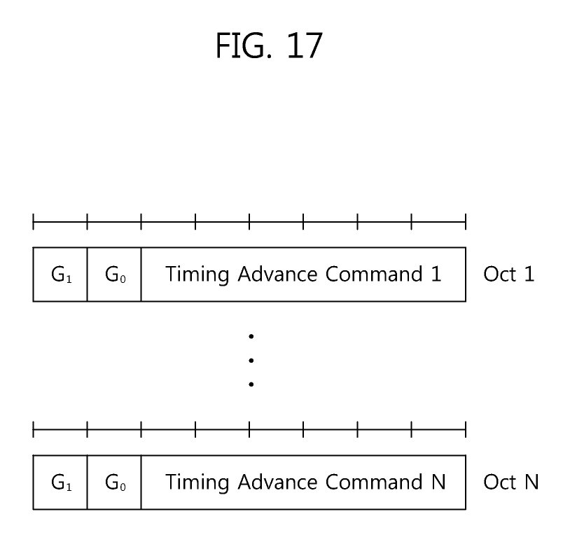

In an example, when the TAT expires, since the timing advance value is not valid further, the UE updates structure information released from an operation and the timing advance is value of a corresponding TAG when the TAT expires. The UE may initiate the random access procedure in order to obtain the updated timing advance value. For example, when the TAG includes the primary serving cell, the UE may initiate the random access procedure and may obtain the updated timing advance value from the base station. When the TAG includes only the secondary serving cell, the UE may perform the random access procedure only when the indicator that indicates the initiation of random access is received from the base station so that the UE may obtain the updated timing advance value. When the timing advance value of the TAG in which the TAT expires is received from the base station after the TAT expires, the TAT is started after updating the received timing advance value. The timing advance value may be defined as control information of an MAC layer, which will be described in detail with reference to FIGS. 16 and 17.

FIG. 16 is a block diagram illustrating the structure of a medium access control (MAC) element according to an example of the present invention.

Referring to FIG. 16, an MAC CE includes index fields G₁ and G₀ and a TAC field of a TAG. Here, G₁ and G₀ bits are bit information indicating the indexes of the TAG. The TAG indexes are defined in TAG forming information transmitted from the base station to the UE. For example, when the number of TAGs is four and the indexes of the TAGs are 1, 2, 3, and 4, G₁ and G₀ may be displayed as {00, 01, 10, and 11}, respectively. When the number of maximum TAGs is two, G1 bit is configured as Reserved Bit®.

When the UE may simultaneously transmit the timing advance value to a plurality of TAGs, as illustrated in FIG. 17, the plurality of timing advance value may be simultaneously transmitted to continuously formed TACs.

FIG. 17 is a block diagram illustrating the structure of an MAC element according to another example of the present invention.

Referring to FIG. 17, the MAC CE includes octet 1 Oct1, . . . , and octet N Oct N. Each of the octets includes the index fields G₁ and G₀ and the TAC field of the TAG. The first octet includes the index fields of a first TAG indicating the indexes of the TAG1 and a first TAC field indicating the timing advance value of the TAG1. The Nth octet includes the index fields of an Nth TAG indicating the indexes of the TAG N and an Nth TAC field indicating the timing advance value of the TAG N.

Referring to FIG. 6, in another example, in a timing advance value updating procedure, a release request message for requesting the transmission holding mode to be released is transmitted to the base station, which may be applied when a network (a wireless business operator) may not grasp the position of the UE, the position of a repeater, or both of the position of the UE and the position of the repeater.

In still another example, in addition to the operation of entering the transmission holding mode, the timing advance value updating procedure may be defined as a procedure of the UE requesting the base station for the updated timing advance value since the timing advance value is not valid. The procedure of requesting the base station for the updated timing advance value may include a procedure of requesting the random access procedure to be initiated. At this time, the UE transmits a message for requesting the random access procedure to be initiated to the base station. At this time, the message may be transmitted to one serving cell in the TAG including the primary serving cell. The message may be transmitted to the primary serving cell.

When the updated timing advance value is obtained, the UE may perform the uplink transmission based on the updated timing advance value.

In S610, when it is determined that the timing advance value is valid, the UE performs the uplink transmission in the secondary serving cell based on the pre-configured timing advance value S625.

In the above procedures, the UE may transmit information on the position of the UE to the base station. When the position information is not necessary and the releasing condition is not satisfied, the UE does not stand by until the TAT expires but immediately transmits the release request message to the base station.

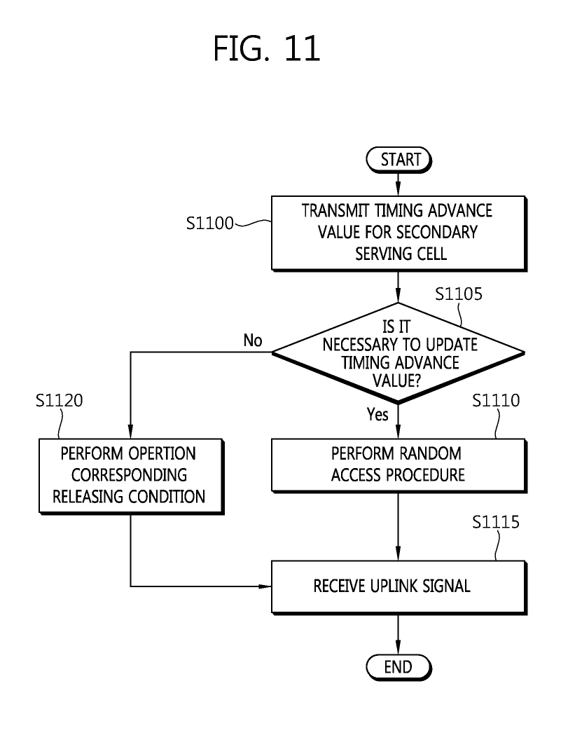

FIG. 11 is a flowchart illustrating a method of performing uplink synchronization by a base station according to an example of the present invention.

Referring to FIG. 11, the base station transmits the timing advance value of the secondary serving cell to the UE S1100. The timing advance value is indicated by the TAC included in the MAC CE transmitted from the base station to the UE as described above or by the TAC CE transmitted from the base station to the UE.

The base station determines whether it is necessary to update the timing advance value provided to the current UE for the secondary serving cell S1105, which is related to the operation of the UE of determining whether the releasing condition is satisfied. When it is determined that it is not necessary to update the timing advance value, the base station may perform an operation for releasing the transmission holding mode of the UE. When it is determined that it is necessary to update the timing advance value, the base station may perform is an operation for updating the timing advance value of the UE.

In an example, the base station may determine whether the timing advance value is updated based on the position information of the repeater and the position information of the UE. For this purpose, when the base station must previously obtain the position information of the repeater and the position information of the UE, a procedure of obtaining the position information of the repeater and the position information of the UE may be performed before S1105 (not shown in the drawing). The base station obtains the position information of the repeater and the position information of the UE and may determine that it is necessary to update the timing advance value when the distance between the position of the repeater and the position of the UE is no more than a threshold distance Dₜₕ. When the distance between the position of the repeater and the position of the UE is larger than the threshold distance, the base station may determine that it is not necessary to update the timing advance value. Hereinafter, a method of obtaining the position information of the repeater and the position information of the UE will be described.

The network (or the wireless business operator) has a right to install the repeater in relation to the position information of the repeater. For example, the wireless business operator may install a plurality of repeaters in order to prevent services from being stopped in a shadow zone or in order to extend a cell service region. The position information of the repeater may be used in accordance with the kind of the network or the wireless business operator or not. Network equipments may use an operations and maintenance (O&M) protocol or an operations, administration, and maintenance (OAM) protocol in order to obtain the position information of the repeater. The position information of the repeater is manually stored in specific network maintenance and repair servers installed by wireless business operators and the stored position information of the repeater may be transmitted to the network equipments including the base station using network protocols specialized by the wireless business operators.

The wireless communication system may use various methods in order to grasp the position information of the UE in relation to the position information of the UE. First, there is a method of confirming the base station that communicates with the current UE and of determining whether the UE exists in the service area of the base station. The method has an advantage in that the network may grasp the position of the UE without additional signaling. However, the position of the UE may be roughly grasped.

Second, there is a method of the base station confirming the CSI transmitted from the UE to determine that the UE is close to the base station when a channel state is good and to determine that the UE is remote from the base station when the channel state is not good. In the method, it is possible to estimate the distance between the base station and the UE from the position of the UE grasped by the first method. However, since it is not possible to know the direction of the UE, it is possible to roughly grasp the position of the UE.

Third, there is a method of a single UE receiving position reference signals transmitted from cells that exist in no less than three physically separated points, of estimating the distance the UE and the cells using the intensities of the position reference signals, and of estimating the position of the UE on a two-dimensional plane using a triangulation method of determining the point at which three concentric circles meet as the position of the UE using the measured distance. The method has advantage in that a correct position of x-y coordinates may be grasped. However, an additional downlink reference signal for estimating the position is to be defined. In addition, since only the UE may grasp the position information, in order to obtain the position information on the network, the UE must transmit the position information to the base station.

Fourth, there is a method of configuring connection between the UE and the network in order to estimate the position of the UE or of collecting information for estimating the position of the UE on the network using information provided by the UE or the intensity of the reference signal transmitted by the UE to estimate the position of the UE on the network using the collected information. In the method, the position of the UE may be estimated on the network in real time without an additional reference signal for estimating the position in the downlink.

Fifth, there is a method of transmitting the position information obtained using a position estimating apparatus (for example, a global positioning system (GPS)) mounted in the UE to the network. The method has advantage in that altitude as well as the x-y coordinates of the third method may be grasped. However, an additional equipment for estimating the position such as a satellite and a GPS receiver is necessary and the UE must transmit the position information to the base station in order to obtain the position information from the network.

Sixth, the base station receives a message indicating that the uplink timing adjusted based on the timing advance value transmitted to the UE is valid from the UE through the primary serving cell and determines whether it is necessary to update the timing advance value based on the message. It is determined by the UE whether the uplink timing is valid using a change in the downlink timing value measured in accordance with time based on a downlink timing reference for the secondary serving cell. For example, the change in the downlink timing value may be a difference between a first downlink timing value measured in a first duration and a second downlink timing value measured in a second duration.

On the other hand, the message may indicate that the uplink timing is not valid when the change in the downlink timing value is no less than the threshold value. The message may include a message for requesting the base station to initiate the random access procedure used for the UE obtaining a new timing advance value.

In S1105, when it is determined that it is necessary to update the timing advance value provided to the current UE for the secondary serving cell, the base station transmits a PDCCH command of ordering the random access procedure to be initiated to the UE to perform the random access procedure S1110. When the timing advance value is successfully updated for the UE by the random access procedure, the base station receives the uplink signal transmitted from the UE based on the updated timing advance value S1115.

In S1105, when it is determined that it is not necessary to update the timing advance value provided to the current UE for the secondary serving cell, the base station performs an operation corresponding to a releasing condition for releasing the transmission holding mode of the UE S1120. The operation corresponding to the releasing condition includes an operation of transmitting the uplink grant indicating resource for uplink transmission to the UE. The operation corresponding to the releasing condition includes an operation of transmitting information of requesting the transmission of the SRS or the CSI to the UE. The operation corresponding to the releasing condition is to release the transmission holding mode of the UE. Therefore, the base station receives the uplink signal transmitted by the UE based on the pre-configured timing advance value S1115.

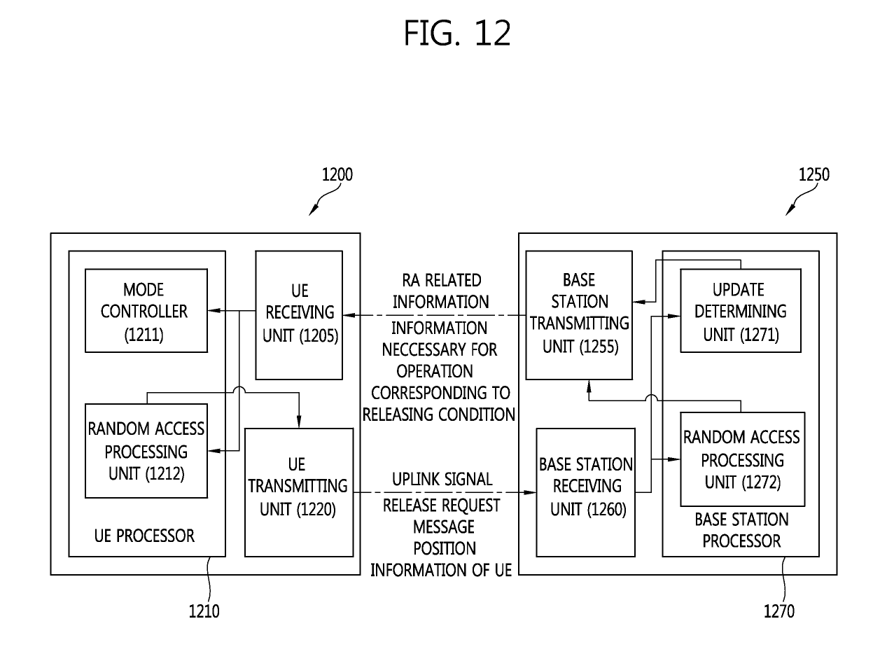

FIG. 12 is a block diagram illustrating a UE and a base station according to an example of the present invention.

Referring to FIG. 12, a UE 1200 includes a UE receiving unit 1205, a UE processor 1210, and a UE transmitting unit 1220. The UE processor 1210 includes a mode controller 1211 and a random access processing unit 1212.

The UE receiving unit 1205 receives an indicator (a PDCCH order) indicating the initiation of the random access procedure, random access related information such as the random access response message including the TAC, and the MAC CE including the TAC from the base station 1250. The TAC is information indicating the timing advance value. The UE receiving unit 1205 receives information required for the operation corresponding to the releasing condition such as the uplink grant, the CSI request information, and the SRS request information from the base station 1250.

The mode controller 1211 adjusts the uplink timing based on the timing advance value of the TAG including the secondary serving cell configured in the UE 1200, determines whether the timing advance value is valid, and determines whether the releasing condition is satisfied.

The operation of the mode controller 1211 determining whether the timing advance value is valid includes, for example, the operation corresponding to S610 in FIG. 6. For example, the mode controller 1211 measures the change in the downlink timing value in accordance with time based on the downlink timing reference for the secondary serving cell and may determine the validity of the uplink timing using the change in the measured downlink timing value. In an example, the mode controller 1211 measures the first downlink timing value in the first duration and the second downlink timing value in the second duration to calculate a difference between the first downlink timing value and the second downlink timing value and to determine the difference as the change in the downlink timing value.

The mode controller 1211 forms a message including a result of determining the validity to transmit the message to the UE transmitting unit. For example, the mode controller 1211 may form the message to indicate that the uplink timing is not valid when the change in the measured downlink timing value is no less than the threshold value. The mode controller 1211 may form the message to request the random access procedure used for obtaining a new timing advance value to be initiated.

When it is determined that the timing advance value is not valid, the mode controller 1211 configures the UE 1200 in the transmission holding mode. When the UE 1200 is configured in the transmission holding mode, the UE transmitting unit 1220 does not transmit any uplink signal to the activated serving cells in the TAG. Here, the uplink signal includes periodical SRS, a periodical CSI report, or a scheduled signal.

When it is determined that the timing advance value is valid, the mode controller 1211 allows the UE transmitting unit 1220 to transmit the uplink signal in the secondary serving cell based on the pre-configured timing advance value.

The operation of the mode controller 1211 of determining whether the releasing condition is satisfied includes, for example, the operation corresponding to S620 in FIG. 6. When it is determined that the releasing condition is satisfied, the mode controller 1211 releases the transmission holding mode and allows the UE transmitting unit 1220 to transmit the uplink signal in the secondary serving cell based on the pre-configured timing advance value.

When it is determined that the releasing condition is not satisfied, the mode controller 1211 stands by until the TAT indicating the valid period of the timing advance value expires or orders the random access processing unit 1212 to perform the timing advance value updating procedure.

The random access processing unit 1212 controls the random access procedure based on the RA related information obtained by the UE receiving unit 1205. For example, the random access processing unit 1212 obtains the timing advance value from the random access response message or obtains the timing advance value from the MAC CE for the TAC. In addition, the random access processing unit 1212 drives and stops the TAT and has the TAT expire and performs the timing advance value updating procedure.

For example, when the TAT expires, since the timing advance value is not valid further, the random access processing unit 1212 updates structure information released from an operation and the timing advance value of a corresponding TAG when the TAT expires. The random access processing unit 1212 may initiate the random access procedure in order to obtain the updated timing advance value. For example, when the TAG includes the primary serving cell, the random access processing unit 1212 may initiate the random access procedure and may obtain the updated timing advance value from the base station 1250. When the TAG includes only the secondary serving cell, the random access processing unit 1212 may perform the random access procedure only when the indicator that indicates the initiation of random access is received from the base station 1250 so that the random access processing unit 1212 may obtain the updated timing advance value.

The random access processing unit 1212 may generate the release request message for requesting the transmission holding mode to be released. The release request message may be a message for requesting the random access procedure used for requesting the updated timing advance value to be re-stared. At this time, the release request message may be transmitted to one serving cell in the TAG including the primary serving cell.

The UE transmitting unit 1220 transmits the uplink signal to the base station 1250 based on the pre-configured timing advance value or the updated timing advance value or transmits the release request message, the message including the result of determining the validity, or the position information of the UE to the base station 1250.

The base station 1250 includes a base station transmitting unit 1255, a base station receiving unit 1260, and a base station processor 1270. The base station processor 1270 includes an update determining unit 1271 and a random access processing unit 1272.

The base station transmitting unit 1255 transmits the indicator indicating the initiation of the random access procedure, the RA related information such as the random access response message including the TAC, and the MAC CE including the TAC to the UE 1200. The TAC is information indicating the timing advance value. The base station transmitting unit 1255 transmits information required for the operation corresponding to the releasing condition such as the uplink grant, the CSI request information, and the SRS request information to the UE 1200.

The base station receiving unit 1260 receives the uplink signal transmitted by the UE 1200 based on the pre-configured timing advance value or the updated timing advance value or receives the release request message, the message including the result of determining the validity, or the position information of the UE from the UE 1200.

The update determining unit 1271 determines whether it is necessary to update the current timing advance value in the secondary serving cell configured in the UE 1200. The operation of the update determining unit 1271 of determining whether it is necessary to update the current timing advance value may include the operation corresponding to S1105 of FIG. 11.

When it is determined that it is necessary to update the timing advance value provided to the current UE 1200 for the secondary serving cell, the update determining unit 1271 controls the random access processing unit 1272 to generate the indicator indicating the initiation of the random access procedure. The random access processing unit 1272 controls the base station transmitting unit 1255 to transmit the indicator and the random access response message including the updated timing advance value to the UE 1200. When the UE 1200 successfully updates the timing advance value by the random access procedure, the base station receiving unit 1260 receives the uplink signal transmitted from the UE 1200 based on the updated timing advance value.

When it is determined that it is not necessary to update the timing advance value provided to the current UE 1200 for the secondary serving cell, the update determining unit 1271 controls the random access processing unit 1272 and the base station transmitting unit 1255 to perform the operation corresponding to the releasing condition for releasing the transmission holding mode of the UE 1200. The operation corresponding to the releasing condition includes the operation of the base station transmitting unit 1255 of transmitting the uplink grant indicating resource for the uplink transmission to the UE 1200. The operation corresponding to the releasing condition includes the operation of the base station transmitting unit 1255 transmitting information of requesting the transmission of the SRS or the CSI to the UE 1200. The operation corresponding to the releasing condition is releasing the transmission holding mode of the UE 1200. Therefore, the base station receiving unit 1260 receives the uplink signal transmitted by the UE 1200 based on the pre-configured timing advance value.

The random access processing unit 1272 generates the message related to the random access procedure and controls the random access procedure.

The timing advance value is secured and the validity of the timing advance value is determined so that it is possible to prevent uplink interference from being generated due to a difference in timing advance values and to prevent capability from deteriorating due to the uplink interference. In addition, since it is not necessary to perform an additional procedure of updating the pre-configured timing advance value to a new timing advance value, it is possible to simplify the random access procedure and to prevent delay from being generated due to the additional procedure.

In the above-described system, the methods are described based on the flowcharts as a series of procedures or blocks. However, the present invention is not limited to the order of the procedures. A certain procedure may be performed in a different order from another procedure or may be simultaneously performed with another procedure. In addition, those skilled in the art may understand that the procedures illustrated in the flowcharts are not exclusive and another procedure may be included or one or more procedures of the flowcharts may be deleted without affecting the scope of the present invention.

The above embodiments include various types of examples. All of the combinations for illustrating the various types may not be described. However, those skilled in the art may recognize that another combination may be performed. Therefore, the present invention includes all of the modifications in the following claims.

What is claimed is:

1. A method of performing uplink synchronization by a user equipment (UE), the method comprising:
adjusting uplink timing based on a timing advance value of a timing advance group (TAG) including a secondary serving cell configured in the UE;
measuring a change in a downlink timing value based on a downlink timing reference for the secondary serving cell;
determining validity of the uplink timing by using the change in the downlink timing value; and
transmitting a message including a result of determining the validity on a primary serving cell to a base station.

2. The method of claim 1, wherein the result of determining the validity indicates that the uplink timing is not valid when the change in the downlink timing value is no less than a threshold value.

3. The method of claim 2, wherein the message comprises a message for requesting initiation of a random access procedure used for obtaining a new timing advance value.

4. The method of claim 1, wherein measuring the change in the downlink timing value comprising:
measuring a first downlink timing value in a first duration;
measuring a second downlink timing value in a second duration; and
calculating a difference between the first downlink timing value and the second downlink timing value,
wherein the change in the downlink timing value is defined by the calculated difference

5. The method of claim 1, further comprising receiving a physical downlink control channel (PDCCH) order indicating the initiation of random access in the secondary serving cell from the base station as a response for the message.

6. A UE for performing uplink synchronization, comprising:
a mode controller for adjusting uplink timing based on a timing advance value of a timing advance group (TAG) including a secondary serving cell configured in the UE, for measuring a change in a downlink timing value based on a downlink timing reference for the secondary serving cell, and for determining validity of the uplink timing using the change in the downlink timing value; and
a transmitting unit for transmitting a message including a result of determining the validity on a primary serving cell to a base station.

7. The UE of claim 6, wherein the mode controller configures the message to indicate that the uplink timing is not valid when the change in the downlink timing value is no less than a threshold value.

8. The UE of claim 7, wherein the mode controller configures the message to request initiation of a random access procedure used for obtaining a new timing advance value.

9. The UE of claim 6, wherein the mode controller measures a first downlink timing value in a first duration, measures a second downlink timing value in a second duration, calculates a difference between the first downlink timing value and the second downlink timing value, and determines the calculated difference as the change in the downlink timing value.

10. The UE of claim 6, further comprising a receiving unit for receiving a PDCCH command that indicates initiation of random access in the secondary serving cell from the base station in response to the message.

11. A method of performing uplink synchronization by a base station, the method comprising:
transmitting, to a user equipment (UE), information including a timing advance value for adjusting uplink timing of a secondary serving cell configured in the UE;
receiving, on a primary serving cell from the UE, a message indicating whether the uplink timing adjusted based on the timing advance value is valid; and
transmitting, to the UE, a PDCCH command indicating initiation of a random access procedure in the secondary serving cell in response to the message,
wherein whether the uplink timing is valid is determined at the UE by using a change in a downlink timing value measured based on a downlink timing reference for the secondary serving cell.

12. The method of claim 11, wherein the message indicates that the uplink timing is not valid when the change in the downlink timing value is no less than a threshold value.

13. The method of claim 12, wherein the message comprises a message for requesting initiation of a random access procedure used for obtaining a new timing advance value.

14. The method of claim 11, wherein the change in the downlink timing value is defined by a difference between a first downlink timing value measured in a first duration and a second downlink timing value measured in a second duration.

15. A base station for performing uplink synchronization, comprising:
a transmitting unit for transmitting, to the UE, information including a timing advance value for adjusting uplink timing of a secondary serving cell configured in a UE; and
a receiving unit for receiving, on a primary serving cell from the UE, a message indicating whether the uplink timing adjusted based on the timing advance value is valid,
wherein the transmitting unit transmits, to the UE, a PDCCH order indicating initiation of a random access procedure in the secondary serving cell in response to the message, and
wherein whether the uplink timing is valid is determined at the UE by using a change in a downlink timing value measured based on a downlink timing reference for the secondary serving cell.

16. The base station of claim 15, wherein the receiving unit receives the message indicating that the uplink timing is not valid when the change in the downlink timing value is no less than a threshold value.

17. The base station of claim 16, wherein the receiving unit receives the message for requesting initiation of a random access procedure used for obtaining a new timing advance value.

18. The base station of claim 15, wherein the change in the downlink timing value is defined by a difference between a first downlink timing value measured in a first duration and a second downlink timing value measured in a second duration.
